(19) United States
(12) Patent Application Publication
(10) Pub. No.: US 2022/0303320 A1
(43) Pub. Date: Sep. 22, 2022

(54) PROJECTION-TYPE VIDEO CONFERENCE SYSTEM AND VIDEO PROJECTING METHOD

(71) Applicant: AMPULA INC., BELLEVUE, WA (US)

(72) Inventor: YAJUN ZHANG, SAN JOSE, CA (US)

(21) Appl. No.: 17/203,790

(22) Filed: Mar. 17, 2021

(51) Int. Cl. H04L 29/06; H04N 7/14; H04N 7/15

(52) U.S. Cl. CPC H04L 65/4015; H04N 7/142; H04N 7/147; H04N 7/155; H04L 65/403

(57) ABSTRACT

The embodiments of the disclosure provide a projection-type video conference system including a camera assembly to acquire image information of a conference scene and generate a conference video, an audio input assembly to collect voice signals of the conference scene, a signal processing assembly to copy the voice information to generate a copied voice information and convert it to generate a text information, which is output together with the conference video, a projection assembly to display the conference video and the text information synchronously. The signal processing assembly performs image fusion between the text information and each frame of the conference video to generate a conference video with subtitle information, and output together with the voice information through a cloud service synchronously. It can project a video conference with subtitle information together, which has high integration and is convenient to carry, and a visualization of voice information is realized.

### TECHNICAL FIELD

The present disclosure relates to the technical field of video conference, and particularly to a projection-type video conference system and a video projecting method.

### BACKGROUND

In recent years, with the raging of epidemic, video conference with the advantages of convenience, non-contacting, and real-time is favored by plenty of companies, and the communication mode of video conference has also been rapidly developed. However, only video images in different scenarios are considered and designed by current video conference, and the other information collected from the scene are almost not used. Under special circumstances, people on both sides of the video conference cannot capture and identify the voice signals, or it is even difficult to recognize the voice signals of the other side, resulting in a poor experience. Meanwhile, a hardware-based video conference system enables a video conference system by combining cameras, TV screens, speakers, microphones and a conference controlling device (such as a computer). However, for this kind of conference system, it is expensive in terms of the various devices, and has poor flexibility in installation and usage, as well as large volume, which is not convenient to carry.

### SUMMARY

According to an embodiment, a projection-type video conference system may include: a camera assembly configured to acquire image information of a conference scene and generate a conference video; an audio input assembly configured to collect voice signals of the conference scene, the voice signals comprising a recognizable voice instruction and voice information; a signal processing assembly configured to copy the voice information to generate a copied voice information, convert the copied voice information to generate a text information, which is output together with the conference video; and a projection assembly configured to display the conference video and the text information synchronously. The signal processing assembly is configurable to perform image fusion on the text information and each frame of the conference video to generate a conference video with subtitle information, and output together with the voice information through a cloud service synchronously.

According to an embodiment, a video projecting method for performing a video conference is provided, which may be applicable to a video conference system as mentioned above. The video projecting method may include: acquiring image information of a conference scene of the video conference by a camera assembly to generate a conference video; acquiring voice signals of the conference scene collected by the audio input assembly; determining current subtitle switch state, and if it is on, copying the voice information to generate a copied voice information and converting it to obtain a text information to be output with the conference video synchronously; fusing the text information with each frame of the conference video to obtain a conference video with subtitle information; transmitting the conference video with the subtitle information to the projection assembly synchronously; and storing the text information to the cache.

As mentioned above, the projection-type video conference system provided by embodiments of the present disclosure may include beneficial effects as: the video conference system incorporates a camera assembly, an audio input assembly, a signal processing assembly and a projection assembly with a high level of integration. The camera assembly can capture the conference scene and provide a high-definition panoramic effect. The signal processing assembly recognizes and processes the voice signals collected by the audio input assembly, copies and converts the voice information of the voice signals in the conference scene into text information, and fuses the text information with the conference video collected by the camera assembly to generate a conference video with subtitle information, which realizes a visual presentation of the voice information. Meanwhile, the projection assembly can project the high-definition video captured by the camera assembly or the video sent from another party joining the conference. Since the projection assembly is utilized to display the conference scene, the video can be directly projected onto the wall without the need for a display screen. This makes it small in size and convenient for the user to carry. In addition, voice control is introduced into the video conference system, which provides voice recognition and voice control functions; in this way, the video conference system may be controlled through voice recognition and control, for example, the turning on/off of the subtitle switch and the like may be controlled by means of voice control. Hence, intelligent control may be provided without controlling the device manually by the user, simplifying the user's operation.

### BRIEF DESCRIPTION OF THE DRAWINGS

In order to more clearly explain the technical solutions in the embodiments of the present disclosure, drawings needed for the description of the embodiments will be simply introduced below. Obviously, the drawings mentioned hereafter just illustrate some embodiments of the present disclosure. For those of ordinary skill in the art, other drawings may also be obtained from these drawings without any creative work. In the drawings,

FIG. 1 is a schematic structural diagram illustrating a video conference system according to an embodiment of the present disclosure.

FIG. 2 is a schematic structural diagram illustrating a signal processing assembly according to an embodiment of the present disclosure;

FIG. 3 is a schematic structural diagram illustrating a signal processing assembly according to an second embodiment of the present disclosure signal processing assembly.

FIG. 4 is a schematic structural diagram illustrating a signal processing assembly according to an second embodiment of the present disclosure signal processing assembly.

FIG. 5 is a schematic flowchart of a video projecting method for performing a video conference by video conference system according to an embodiment of the present disclosure.

FIG. 6 is a schematic flowchart of a video projecting method for performing a video conference by video conference system according to a second embodiment of the present disclosure.

FIG. 7 is a schematic flowchart of a video projecting method for performing a video conference by video conference system according to a third embodiment of the present disclosure.

FIG. 8 is a schematic flowchart of a video projecting method for performing a video conference by video conference system according to a fourth embodiment of the present disclosure.

### DETAILED DESCRIPTION OF PREFERRED EMBODIMENTS

The technical solutions in the embodiments of the present disclosure will be clearly and completely described below in conjunction with the drawings in the embodiments of the present disclosure. Obviously, the described embodiments are only a part of the embodiments of the present disclosure, rather than all the embodiments thereof. Based on the embodiments in this disclosure, all other embodiments, obtained by those skilled in the art without any creative work, shall fall within the protection scope of this disclosure.

At present, only video images in different scenarios are considered and designed by existing video conference. The existing video conference is composed of a TV screen, a camera, a microphone, a speaker, a remote control and a computer. The camera is usually installed on the top of the TV screen so as to maximize the capture of the conference scene. However, for this kind of conference system, an overlap phenomenon occurs in case of too many people. In an implementation, after the captured video is transmitted to a remote end, some people can be displayed clearly, but those people located a bit further back are either overlapped with or blocked by others, or cannot be clearly displayed for being too far away from the camera. The microphone and speaker are usually far away from the TV screen, and arranged on a conference table to facilitate the collection of voice information from conference participants and the broadcasting of the voice information sent from another party joining the conference. Since the audio and video devices are independent of each other, synchronization distortion happens in case of poor network performance, which degrades the quality of the conference. The computer may be configured to start and manage video conferences, share screens, or the like. That is, the existing video conference makes less use of the other information collected from the conference scene. Under special circumstances, for example, plenty of participants, different language habits or a noisy environment, where people on both sides of the video conference cannot capture and identify the voice signals, resulting in a poor experience. At the same time, the existing video conference system, which combines the camera, TV screen, audio, microphone and conference control equipment (such as computer) to establish a dial and talk video conference with the other party's video conference system, also has the disadvantages of expensive equipment, poor installation and use flexibility, large volume and inconvenient carrying.

The present disclosure aims to solve the problems in the existing video conference system, and provide a new video conference experience to the users. A video conference system is provided by embodiments of the present disclosure, which is portable and can be used at any time as required. It integrates high-definition panoramic audio and video, replaces the traditional TV screen or monitor with high-definition and high-brightness projection assembly, and makes the projection size adjusted according to the projection distance. It is suitable for group meetings as well as family and personal use, and has a low cost. Moreover, the collected voice signals are recognized and transformed to generate a conference video with subtitle information, which realizes a visualization of voice information. Furthermore, it can be configured and managed through a mobile phone or a computer. With the assistance of various functional modules of the cloud service, an optimal point-to-point video connection with another conference device can be established, to provide an optimal video conference effect.

Referring to FIG. 1-FIG. 4, particularly to FIG. 1, which is a schematic structural diagram illustrating a video conference system according to an embodiment of the present disclosure, the video conference system 10 may include a camera assembly 11, an audio input assembly 12, a signal processing assembly 13, a projection assembly 14, an audio output assembly 15 and a cache 16.

The camera assembly 11 may be configured to acquire panoramic video of a conference scene to generate a conference video and send the conference video to the signal processing assembly 13. The camera assembly 11 may include a camera. The camera may include a wide-angle lens, and it may be a 360-degree panoramic camera or a camera covering a part of the scene. Two or three wide-angle lenses may be adopted. Each wide-angle lens may support a resolution of 1080P or 4K or more. The videos captured by all the wide-angle lens may be spliced together by means of software to generate high-definition videos of the 360-degree scene, with such generated high-definition panoramic video remained at the resolution of 1080P. During the conference, all participants in the conference may be tracked in real time and the speakers may be located and identified, by performing artificial intelligence (AI) image analysis on the panoramic video. Furthermore, virtual reality technology can be used to further optimize the collected video information to enhance the participants' sense of experience.

In an embodiment, the camera assembly 11 may further include a housing, a motor and a lifting platform (which are not shown). The motor and the lifting platform may be arranged within the housing, and the lifting platform may be arranged above the motor for carrying the camera. The camera may be arranged on the lifting platform. The motor may be configured to drive, upon receiving a signal instruction, the lifting platform to move up and down and thus bring the camera to move up and down, so as to make the camera protrude out of or hide inside the housing. As mentioned above, the position of the camera can be accurately controlled, which improves the accuracy of the conference video. At the same time, the camera can be hidden in the shell which effectively avoids the dust damage.

In another embodiment, the camera assembly 11 may further include a housing, a wireless control device and a four-axis aircraft. The wireless control device may be arranged within the housing. The four-axis aircraft is set within the control range of the wireless control device. The camera may be arranged on the four-axis aircraft. The four axis aircraft is used to drive the camera to fly out of the shell after receiving the command from the wireless control device, and collect the 360 degree panoramic video information. Through this implementation, the camera of the application can be separated from the projection-type video conference system to capture more azimuth information, and can flexibly adjust the orientation and position of the camera according to different needs, and switch the meeting under different fields of view of video conference information, which can adapts to more complex application scenarios.

The audio input assembly 12 may be configured to collect voice signals. The audio input assembly 12 may be a microphone, or may adopt an array of microphones supporting 360-degree surround in the horizontal direction. For example, it can adopt an array of 8 digital Micro Electro Mechanical System (MEMS) microphones, which are evenly and circumferentially distributed in the horizontal plane and each have a function of Pulse Density Modulation (PDM), for interaction with near and far fields; alternatively, it may adopt an array of 8+1 microphones, with one microphone located in the center to capture far-field audio and send the voice signal to the signal processing assembly 13.

The signal processing assembly 13 is configured to copy the voice information to generate a copied voice information, convert the copied voice information to generate a text information, which is output together with the conference video. The signal processing assembly 13 is also used to perform image fusion on the text information and each frame of the conference video to generate a conference video with subtitle information, and output together with the voice information through a cloud service synchronously.

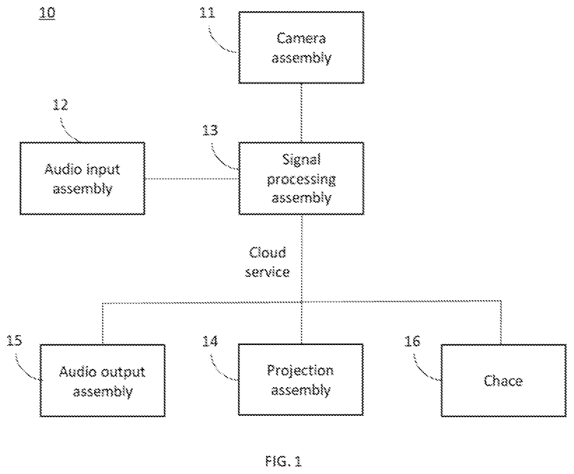

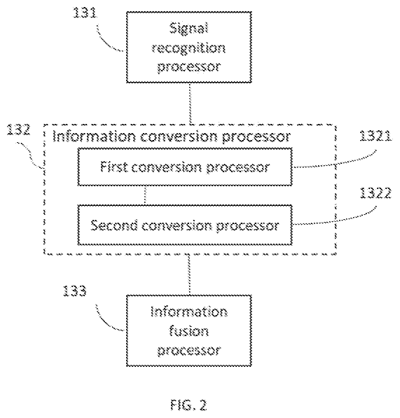

In an embodiment, referring to FIG. 2, the signal processing assembly 13 may include a signal recognition processor 131, an information conversion processor 132 and an information fusion processor 133.

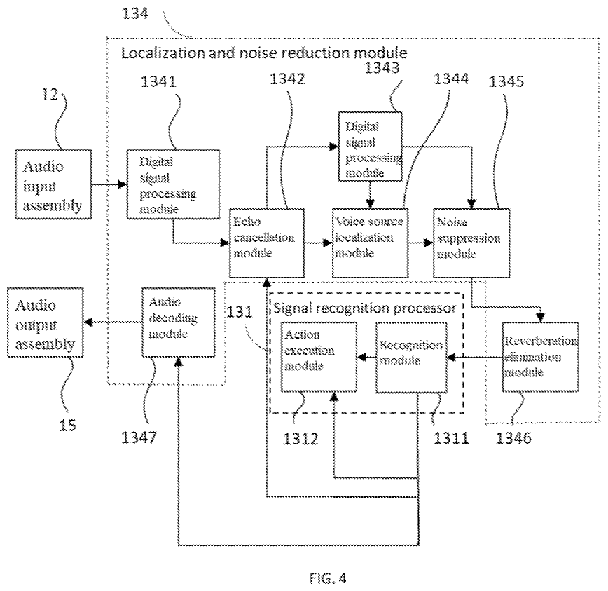

The signal recognition processor 131 is configured to recognize a subtitle switch state information corresponding to the subtitle demand. Referring to FIG. 4, the signal recognition processor 131 includes a recognition module 1311 and an action execution module 1312. In an embodiment, the recognition module 1311 is used to identify the on/off state of a physical button of a subtitle switch of the process assembly to obtain the subtitle switch state information and the action execution module 1312 is used to execute an subtitle switch operation corresponding to the subtitle switch state information. Specifically, when the state information of the subtitle switch is “on”, the recognition module 1311 recognize the state information and instruct the action execution module 1312 to turn on the subtitle switch. It should be noted that state information of other physical buttons can also be recognized by the recognition module 1311, and the action execution module 1312 will be instructed to execute an subtitle switch operation corresponding to the state information of other physical buttons.

In another embodiment, the recognition module 1311 is configured to recognize the voice instruction to obtain keyword information, and the action execution module 1312 is configured to perform a subtitle switch operation corresponding to the key information. In a particular embodiment, voice control may be performed based on a local built-in thesaurus. That is, some command keywords may be stored locally in advance to form a thesaurus, with such command keywords including for example “turn on the subtitle switch” and “turn off the subtitle switch” and such confirmation keywords comprise “yes” or “no”. In actual use, it may be detected whether the keyword information recognized from the voice signal input by the user is included in the thesaurus, and if it is, a corresponding operation may be performed. For example, if the recognition module 1311 recognizes that the voice command issued by the user is “turn on the subtitle switch”, the action execution module 1312 may control the subtitle switch to open.

The information conversion processor 132 is configured to copy and convert the voice information to generate a text information output together with the video conference. In an embodiment, referring to FIG. 2, the information conversion processor 132 includes a first conversion processor 1321 and a second conversion processor 1322. The first conversion processor 1321 is configured to copy a current voice information to generate a copied voice information, determine a type of the copied voice information, and convert the copied voice information to an initial text information. The second conversion processor 1322 is configured to change and modify the initial text information to a display text information. For example, the first conversion processor 1321 is integrated with a variety of speech databases, including Chinese, English, Japanese and other foreign languages, via cloud services (not shown). Moreover, dialect sub databases for Chinese speech database including Cantonese, Minnan dialect, Shaanxi dialect, etc. are also set up. It should be noted that the first conversion processor 1321 integrates the conversion rules of the conversion between the above languages and mandarin. If the first conversion processor 1321 determine s that the current voice information is Chinese, it copies the current voice information to generate a copied voice information and determine s the specific types of the current voice information. If it is Cantonese, the first conversion processor 1321 converts the copied voice information into an initial text information according to the conversion rules between Cantonese and mandarin, and transmits the initial text information to the second conversion processor 1322, and the second conversion processor 1322 change and modify the initial text information to a display text information. If the first conversion processor 1321 determine s that the current voice information is English, it copies the current voice information to generate a copied voice information, the first conversion processor 1321 converts the copied voice information into an initial text information according to the conversion rules between English and mandarin, and transmits the initial text information to the second conversion processor 1322. In this embodiment, the second conversion processor 1322 integrates the common thesaurus information via cloud service (not shown). By comparing the initial text information with the phrases and rules in the common thesaurus information words by words, the initial text information is corrected, so that the transformation error, such as common phrase conversion error, sentence breaking error, obvious language defect, etc. can be effectively avoided. With the first conversion processor 1321 and the second conversion processor 1322 of this embodiment, the conference video system of the application can convert different types of voice signals into standard text information, which is convenient for the participants to better receive conference information, and a semantic presentation of voice signals is realized.

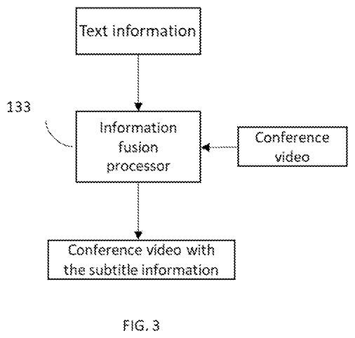

The information fusion processor 133 is configured to process the text information into corresponding matrix information according to a update time of the text information and fuse it with each frame image of the conference video at corresponding time. Referring to FIG. 3, when the information fusion processor 133 detects the text information converted from the current voice signal, it converts the text information into a matrix image with the same resolution as the current frame conference video image, and sums the matrix image and the current frame conference video image to obtain a conference video with subtitle information. It should be noted that, when the information fusion processor 133 converts the text information into a matrix image, a part with higher gray value corresponding to the text details can be assigned to a row in lower middle or upper middle of the matrix image. For example, if the resolution of the current frame conference video image is 1920×1080, then the information fusion processor 133 sets an 1920×1080 empty matrix with 0 gray value, and assigns the gray value information corresponding to the text information to the 1620-1820 rows and 200-880 columns of the empty matrix pixel by pixel, so as to obtain a matrix image corresponding to the text information. The information fusion processor 133 also sum and fuse the matrix image corresponding to the text information with each frame image of the conference video at the corresponding time to generate a conference video with subtitle information. This implementation can effectively fuse the standard text information with the video conference, the calculation method is simple, the fusion speed is fast, and the accurate meaning of the current subtitle can be presented in real time.

In an embodiment, the audio input assembly 12 and signal processing assembly 13 further include a localization and noise reduction module 134, which is configured to determine the localization of the voice signals and reduce the noise of the voice signals. Specifically, the localization and noise reduction module 134 may include a digital signal processing module 1341, an echo cancellation module 1342, a voice source localization module 1343, a beamforming module 1344, a noise suppression module 1345 and a reverberation elimination module 1346, and the localization and noise reduction module 134 process the voice signals and send it to the signal recognition processor 131.

In an implementation, the array of digital microphones may suppress sound pickup in non-target directions by means of beamforming technology, thus suppressing noise, and it may also enhance the human voice within the angle of the voice source, and transmit the processed voice signal to the digital signal processing module 1341 of the signal processing assembly 13.

Turn to FIG. 4, the digital signal processing module 1341 may be configured to digitally filter, extract and adjust the PDM digital signal output by the array of digital microphones, to convert a 1-bit PDM high-frequency digital signal into a 16-bit Pulse Code Modulated (PCM) data stream of a suitable audio frequency. An echo cancellation module 1342 may be connected with the digital signal processing module 1341 to perform echo cancellation processing on the PCM data stream, to generate a first signal. A beamforming module 1344 may be connected with the echo cancellation module 1342 to filter the first signal output by the echo cancellation module 1342, to generate a first filtered signal. A voice source localization module 1343 may be connected with the echo cancellation module 1342 and the beamforming module 1344, and may be configured to detect, based on the first signal output by the echo cancellation module 1342 and the first filtered signal output by the beamforming module 1344, a direction of the voice source and form a pickup beam area. In an implementation, the voice source localization module may be configured to calculate a position target of the voice source and detect the direction of the voice source by calculating, with a method based on Time Difference Of Arrival (TDOA), a difference between the times at which the signal arrives at the individual microphones, and to form the pickup beam area. A noise suppression module 1345 may be connected with the voice source localization module 1343 to perform noise suppression processing on the signal output by the voice source localization module 1343, to generate a second signal. A reverberation elimination module 1346 may be connected with the noise suppression module 1345 to perform reverberation elimination processing on the second signal output by the noise suppression module 1345, to generate a third signal. Because of the localization and noise reduction module 134 in this embodiment, the voice signals from different directions can be effectively recognized, the noise signals from non-positioning position can be reduced and the user experience can be greatly improved.

It should be noted that, the digital signal processing module 1341, the echo cancellation module 1342, the voice source localization module 1343, the beamforming module 1344, the noise suppression module 1345, the reverberation elimination module 1346 and an audio decoding module 1347 may be included in a localization and noise reduction module 134 of the signal processing assembly 13 (see FIG. 4), that is, of the signal processing assembly 13 may be configured to perform the subsequent processing operations on the voice signals output by the audio input assembly 12. Alternatively, the video conference system 10 may include a main processor (not shown), with the main processor including the digital signal processing module 1341, the echo cancellation module 1342, the voice source localization module 1343, the beamforming module 1344, the noise suppression module 1345, the reverberation elimination module 1346 and the audio decoding module 1347, that is, the main processor may be configured to perform the subsequent processing operations on the voice signals output by the audio input assembly 12.

In an implementation, the projection-type video conference system may include a cache. The cache 16 is used to cache the text information output by the signal processing assembly and the cache. Specifically, the cache 16 includes a cache processor 161 and a cache memory 162. The cache processor 161 is configured to determine a current progressing status of the video conference and perform corresponding operations according to a status of the video conference. The cache memory is configured to store the text information in form of a log. The cache 16 in this embodiment effectively stores the converted text information, which can semantically store the voice information output by the participants in the conference scene, so that it is convenient for the staff to effectively record the conference video.

The projection assembly 14 may be configured to display video information of the conference. For example, the projection assembly 14 may display video of an input signal from a computer or an external electronic device, or may also display the panoramic video captured by the camera assembly or another conference scene video sent from another conference device. The conference's screen information to be displayed may be selected on a conference system application installed on the computer and the external electronic terminal. In an implementation, the projection assembly 14 may include the projection processor (not shown), and the projection processor may be configured to receive the conference video with subtitle information sent from other devices and processed by the information processing module 14, and perform projection display. The projection processor may also configured to perform partial identification and delineation on the images of the participants in the conference by means of image analysis and processing algorithms, and then project the images after being subject to partial identification and delineation, in horizontal or vertical presentation, onto an upper side, lower side, left side or right side of the projection area. The projection processor may also be configured to assist the array of microphones in positioning, focusing or magnifying the sound of the speaker in the video conference, by means of the image analysis and processing algorithms.

Preferably, since a laser has advantages of for example high brightness, wide color gamut, true color, obvious orientation and long service life, the projection assembly 14 may adopt a projection technology based on a laser light source, and the output brightness may be 500 lumens or more. As such, the video conference system 10 may output videos having a resolution of 1080P or more, and may be used to project the video coming from the another party joining the conference or realize screen sharing of the electronic terminal devices such as computers or mobile phones. It can be understood that the projection assembly 14 is not limited to adopting the projection technology based on a laser light source, and may also adopt a projection technology based on an LED light source.

The audio output assembly 15 may be configured to play the audio signal sent from the signal processing assembly 13. It may be a speaker or a voice box, and may be for example a 360-degree surround speaker or a locally-orientated speaker.

In another particular embodiment, the electronic device (not shown) may communicate with the video conference system 10 via network. That is, the electronic device and the video conference system 10 may access a same WIFI network, and communicate with each other via the gateway device (not shown). In this case, the video conference system 10 and the electronic device are both configured in the STA mode when they work, and access the WIFI wireless network via the gateway device. The electronic device may find, manage and communicate with the video conference system by means of the gateway device. Both the data acquisition from the cloud or the execution of video sharing by the video conference system 10 need to pass through the gateway device, occupying a same frequency band and interface resource.

In another particular embodiment, the electronic device may directly access the wireless network of the video conference system 10 to communicate therewith, and the wireless communication assembly (not shown) in the video conference system 10 may work in both the STA mode and AP mode, which belongs to single frequency time division communication. Compared with the dual frequency mixed mode, the data rate will be halved.

In another particular embodiment, the electronic device may also communicate with the video conference system 10 through wireless Bluetooth, that is, a Bluetooth channel may be established between the electronic device and the video conference system 10. In this case, the electronic device and the wireless communication assembly in the video conference system 10 all work in the STA mode, and high-speed data may be processed through WIFI, for example, the video stream may be played.

In other particular embodiment, the electronic device may communicate with the video conference system 10 remotely via the cloud service. In remote communication, the electronic device and the video conference system 10 do not need to be on a same network. The electronic device may send a control command to the cloud service, and the command may be transmitted to the video conference system 10 through a secure signaling channel established between the video conference system 10 and the cloud service, thereby enabling communication with the video conference system 10. It should be noted that this mode may also enable communication interactions between different video conference systems.

Based on the various components in the video conference system 10 described above, the working principle of the video conference system 10 will be described below.

The camera assembly 11 collects image information of a conference scene and inputs it to the signal processing module 13. The audio input assembly 12 collects the voice signals of the video conference and inputs them to the signal processing assembly 13. The localization and noise reduction module 134 in the signal processing assembly 14 determine s the localization of the voice signals and reduces the noise of the voice signals and sends the processed voice signal to the signal recognition processor 131. The signal recognition processor 131 recognize the voice instruction. The information conversion processor 132 determine s the different types of voice information, copies the voice information to generate a copied voice information, and convert it to a converted text information, and the information conversion processor 132 also outputs the converted text information to the information fusion processor 133. The information fusion processor 133 fuses the text information with the conference video to obtain a conference video with subtitle information, and then provides the conference video with subtitle information through cloud service to the projection assembly 14. The projection assembly 14 display the conference video with subtitle information. The voice information is sent to the audio output module 15 through the cloud service, and the converted text information is sent to the storage module 16.

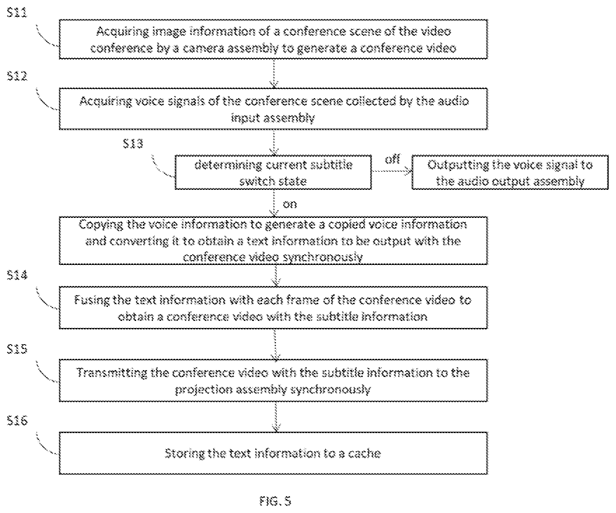

Referring to FIG. 5, a schematic flowchart of video projecting method for performing a video conference by the video conference system according to an embodiment of the present disclosure is shown, and the method implemented by the video conference system may include steps S11 to S16 as follows.

In step S11, acquiring image information of a conference scene of the video conference by a camera assembly to generate a conference video.

Specifically, the image information of the conference scene is acquired by the camera assembly 11 of the video conference system 10.

In step S12, acquiring voice signals of the conference scene collected by the audio input assembly, voice signals include voice instruction and voice information.

Specifically, the audio input assembly 12 of the video conference system 10 may be configured to collect voice signals. The audio input assembly 12 may be a speaker or a voice box with microphone array supporting 360-degree horizontal surround.

Furthermore, the voice signals include voice instruction which can be recognized by the signal recognition processor 131, and the voice instruction are some operations related to the video conference system 10, such as “turn on the subtitle switch” and “turn off the subtitle switch”.

In step S13, determining current subtitle switch state, if it is on (i.e. yes), copying the voice information to generate a copied voice information and converting it to obtain a text information to be output with the conference video synchronously.

Specifically, the signal recognition processor 131 is configured to identify the on/off state of the physical button of the subtitle switch of the signal processing assembly 13 to obtain the subtitle switch state information, or recognize the voice instruction to obtain keyword information and performing a subtitle switch operation corresponding to the keyword information.

If it is off (i.e. no), then the signal processing assembly 13 output the voice signal to the audio output assembly 15.

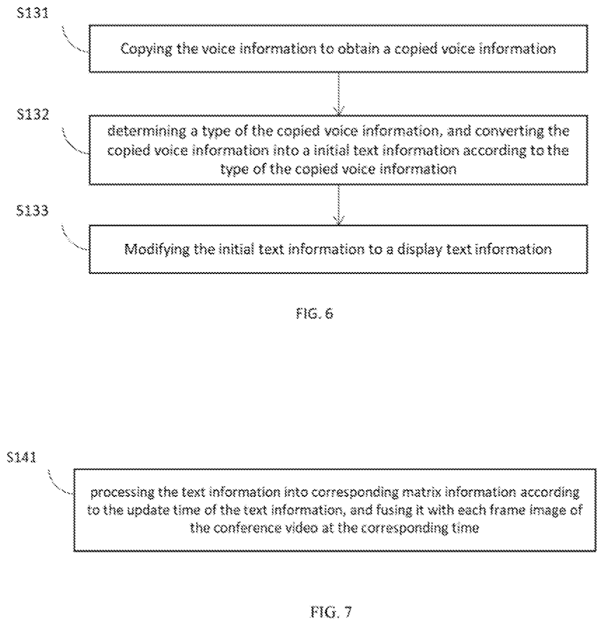

Furthermore, referring to FIG. 6, The step S13 includes:

In step S131, copying the voice information to obtain a copied voice information.

Specifically, the copied voice information is processed after the voice information is copied and backed up.

In step S132, determining a type of the copied voice information, and converting the copied voice information into an initial text information according to the type of the copied voice information.

Specifically, copying a current voice information to generate a copied voice information, determining the type of the copied voice information, and converting the copied voice information to an initial text information. For example, the first conversion processor is integrated with a variety of speech databases, including Chinese, English, Japanese and other foreign languages, via cloud services (not shown). Moreover, dialect sub databases for Chinese speech database including Cantonese, Minnan dialect, Shaanxi dialect, etc. are also set up. It should be noted that the first conversion processor 1321 integrates the conversion rules of the conversion between the above languages and mandarin. If the first conversion processor 1321 determine s that the current voice information is Chinese, it copies the current voice information to generate a copied voice information and determine s the specific types of the current voice information. If it is Cantonese, the first conversion processor 1321 converts the copied voice information into an initial text information according to the conversion rules between Cantonese and mandarin, and transmits the initial text information to the second conversion processor 1322.

In step 133, modifying the initial text information to a display text information.

In an embodiment, the second conversion processor 1322 change and modify the initial text information to a display text information. The second conversion processor 1322 integrates the common thesaurus information via cloud service (not shown). By comparing the initial text information with the phrases and rules in the common thesaurus information words by words, the initial text information is corrected.

In step S14, fusing the text information with each frame of the conference video to obtain a conference video with subtitle information.

As shown in FIG. 7, step S14 further includes:

In step S141, processing the text information into corresponding matrix information according to a update time of the text information, and fusing it with each frame image of the conference video at corresponding time.

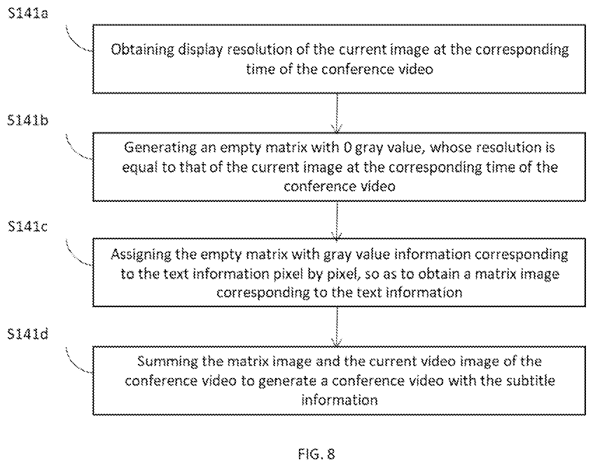

As shown in FIG. 8, step S141 further includes:

In step S141a, obtaining display resolution of the current image at the corresponding time of the conference video.

In step S141b, generating an empty matrix with 0 gray value, whose resolution is equal to that of the current image at the corresponding time of the conference video.

In step S141c, assigning the empty matrix with gray value information corresponding to the text information pixel by pixel, so as to obtain a matrix image corresponding to the text information.

In step S141d, summing the matrix image and the current video image of the conference video to generate a conference video with subtitle information.

As mention above, the standard text information and video conference can be effectively fused, the calculation method is simple, the fusion speed is fast, and the accurate meaning of the current subtitle can be presented in real time.

In step S15, transmitting the conference video with the subtitle information to the projection assembly synchronously.

Specifically, the conference video with subtitle information is projected by the projection assembly 14 of the video conference device 10. Furthermore, the projection assembly 14 is used to display the panoramic video captured by the camera assembly 11 or the conference scene video sent by the other party's conference equipment. The conference video image information to be displayed can be selected on the conference system of the computer and the external electronic terminal.

In step S16, storing the text information to a cache.

As mentioned above, the projection-type video conference system provided by embodiments of the present disclosure may include a camera assembly configured to acquire image information of a conference scene and generate a conference video; an audio input assembly configured to collect voice signals of the conference scene, the voice signals comprising a recognizable voice instruction and voice information; a signal processing assembly configured to copy the voice information to generate a copied voice information, convert the copied voice information to generate a text information, which is output together with the conference video; and a projection assembly configured to display the conference video and the text information synchronously. The signal processing assembly is further configured to perform image fusion on the text information and each frame of the conference video to generate a conference video with subtitle information, and output together with the voice information through a cloud service synchronously.

In an embodiment, the signal processing assembly may include a signal recognition processor which is configured to recognize a subtitle switch state information corresponding to the subtitle demand, and the signal recognition processor is used to identify a on/off state of a physical button of a subtitle switch of the signal processing assembly to obtain the subtitle switch state information, and executing an subtitle switch operation corresponding to the subtitle switch state information

In an embodiment, the signal processing assembly may include a signal recognition processor which is configured to recognize a subtitle switch state information corresponding to the subtitle demand, and the signal recognition processor is used to recognize the voice instruction to obtain keyword information and performing a subtitle switch operation corresponding to the keyword information.

In an embodiment, the signal recognition processor is configured to detect whether the keyword information is included in a preset thesaurus; and perform the subtitle switch operation corresponding to the keyword information when it is determined that the keyword information is included in the preset thesaurus. The keyword information comprises command keywords or confirmation keywords, the command keywords comprise “turn on/off the subtitle switch of the signal processing assembly”, and the confirmation keywords comprise “yes” or “no”.

In an embodiment, the signal processing assembly further includes an information conversion processor, which includes a first conversion processor configured to copy a current voice information to generate a copied voice information, determine a type of the copied voice information, and convert the copied voice information to an initial text information and a second conversion processor configured to change and modify the initial text information to a display text information.

In an embodiment, the projection-type video conference system may include a cache, wherein the cache is used to cache the text information output by the signal processing assembly and the cache includes a cache processor configured to determine a current progressing status of the video conference and perform corresponding operations according to a status of the video conference and a cache memory configured to store the text information in form of a log.

In an embodiment, the audio input assembly and signal processing assembly further include a localization and noise reduction module, which is configured to determine the localization of the voice signals and reduce the noise of the voice signals.

In an embodiment, the projection-type video conference system further includes an audio output assembly configured to play an audio signal sent by the signal processing assembly through the cloud service.

In an embodiment, the step of copying the voice information to generate a copied voice information and converting it to obtain a text information to be output with the conference video synchronously further includes: copying the voice information to obtain a copied voice information; determining the type of the copied voice information, and converting the copied voice information into an initial text information according to the type of the copied voice information; and modifying the initial text information to a display text information.

In an embodiment, the step of fusing the text information with each frame of the conference video to obtain a conference video with subtitle information includes: processing the text information into corresponding matrix information according to a update time of the text information and fusing it with each frame image of the conference video at corresponding time.

In an embodiment, the step of processing the text information into corresponding matrix information according to a update time of the text information, and fusing it with each frame image of the conference video at corresponding time further includes: obtaining display resolution of the current image at the corresponding time of the conference video; generating an empty matrix with 0 gray value, whose resolution is equal to that of the current image at the corresponding time of the conference video; assigning the empty matrix with gray value information corresponding to the text information pixel by pixel, so as to obtain a matrix image corresponding to the text information; and summing the matrix image and the existing video image of the conference video to generate a conference video with subtitle information.

The video conference system incorporates a camera assembly, an audio input assembly, a signal processing assembly and a projection assembly with a high level of integration. The camera assembly can capture the conference scene and provide a high-definition panoramic effect. The signal processing assembly recognizes and processes the voice signals collected by the audio input assembly, copies and converts the voice information of the voice signals in the conference scene into text information, and fuses the text information with the conference video collected by the camera assembly to generate a conference video with subtitle information, which realizes a visual presentation of the voice information. Meanwhile, the projection assembly can project the high-definition video captured by the camera assembly or the video sent from another party joining the conference. Since the projection assembly is utilized to display the conference scene, the video can be directly projected onto the wall without the need for a display screen. This makes it small in size and convenient for the user to carry. In addition, voice control is introduced into the video conference system, which provides voice recognition and voice control functions; in this way, the video conference system may be controlled through voice recognition and control, for example, the turning on/off of the subtitle switch and the like may be controlled by means of voice control. Hence, intelligent control may be provided without controlling the device manually by the user, simplifying the user's operation.

The foregoing are only examples of this disclosure, and do not limit the scope of the disclosure. Any equivalent structure or equivalent process variants made on the basis of the contents of the specification and drawings of this disclosure, or direct or indirect application to other related technical fields, should all be included in the scope protection of this disclosure.

1. A projection-type video conference system, comprising:
a camera assembly configured to acquire image information of a conference scene and generate a conference video;
an audio input assembly configured to collect voice signals of the conference scene, the voice signals comprising a recognizable voice instruction and voice information;
a signal processing assembly configured to copy the voice information to generate a copied voice information, convert the copied voice information to generate a text information, which is output together with the conference video;
a projection assembly configured to display the conference video and the text information synchronously;
wherein the signal processing assembly is further configured to perform image fusion on the text information and each frame of the conference video to generate a conference video with subtitle information, and output together with the voice information through a cloud service synchronously;
wherein the signal processing assembly comprises a first conversion processor and a second conversion processor, the first conversion processor integrates conversion rules between a first language and second languages different from the first language, and the second conversion processor integrates thesaurus information;
wherein the first conversion processor is configured to
copy a current voice information to generate the copied voice information,
determine a language type of the copied voice information,
convert the copied voice information to the initial text information according to the conversion rule between the first language and a corresponding one of the second languages, in response to the language type of the copied voice information being the corresponding one of the second languages; or convert the copied voice information to the initial text information directly, in response to the language type of the copied voice information being the first language; and
wherein the second conversion processor is configured to modify the initial text information to a display text information by correcting the initial text information based on the thesaurus information.

2. The projection-type video conference system according to claim 1, wherein the signal processing assembly comprises a signal recognition processor which is configured to recognize a subtitle switch state information corresponding to the subtitle demand, by:
identifying on/off state of a physical button of a subtitle switch of the signal processing assembly to obtain the subtitle switch state information, and executing an subtitle switch operation corresponding to the subtitle switch state information.

3. The projection-type video conference system according to claim 1, wherein the signal processing assembly comprises a signal recognition processor which is configured to recognize a subtitle switch state information corresponding to the subtitle demand, by:
recognizing the voice instruction to obtain keyword information and performing a subtitle switch operation corresponding to the keyword information.

4. The projection-type video conference system according to claim 3, wherein the signal recognition processor is configured to: detect whether the keyword information is included in a preset thesaurus; and perform the subtitle switch operation corresponding to the keyword information when it is determined that the keyword information is included in the preset thesaurus;
wherein the keyword information comprises command keywords or confirmation keywords, the command keywords comprise “turn on/off the subtitle switch of the signal processing assembly”, and
the confirmation keywords comprise “yes” or “no”.

5. (canceled)

6. The projection-type video conference system according to claim 1, wherein the signal processing assembly further comprises an information fusion processor, which is used to process the text information into corresponding matrix information according to a update time of the text information, and fuse it with each frame image of the conference video at corresponding time.

7. The projection-type video conference system according to claim 1, further comprises a cache, wherein the cache is configured to cache the text information output by the signal processing assembly, and the cache comprises:
a cache processor configured to determine a current progressing status of the video conference and perform corresponding operations according to a status of the video conference; and
a cache memory configured to store the text information in form of a log.

8. The projection-type video conference system according to claim 1, wherein the audio input assembly and the signal processing assembly further comprise a localization and noise reduction module, which is configured to determine the localization of the voice signals and reduce the noise of the voice signals.

9. The projection-type video conference system according to claim 1, wherein the projection-type video conference system further comprises an audio output assembly configured to play an audio signal sent by the signal processing assembly through the cloud service.

10. A video projecting method, comprising:
acquiring image information of a conference scene of the video conference by a camera assembly to generate a conference video;
acquiring voice signals of the conference scene collected by the audio input assembly;
determining current subtitle switch state, and if it is on, copying the voice information to generate a copied voice information and converting it to obtain a text information to be output with the conference video synchronously;
fusing the text information with each frame of the conference video to obtain a conference video with subtitle information;
transmitting the conference video with the subtitle information to the projection assembly synchronously; and
storing the text information to a cache;
wherein the copying the voice information to generate a copied voice information and converting it to obtain a text information to be output with the conference video synchronously comprises:
copying the voice information to obtain a copied voice information;
determining a language type of the copied voice information; converting the copied voice information into the initial text information according to a conversion rule between a first language and a corresponding one of second languages different from the first language, in response to the language type of the copied voice information being the corresponding one of the second languages; or converting the copied voice information into the initial text information directly, in response to the language type of the copied voice information being a first language; and
modifying the initial text information to a display text information by correcting the initial text information based on thesaurus information.

11. (canceled)

12. The video projecting method according to claim 10, wherein fusing the text information with each frame of the conference video to obtain a conference video with subtitle information comprises:
processing the text information into corresponding matrix information according to a update time of the text information, and fusing it with each frame image of the conference video at corresponding time.

13. The video projecting method according to claim 12, wherein processing the text information into corresponding matrix information according to an update time of the text information, and fusing it with each frame image of the conference video at corresponding time further comprises:
obtaining display resolution of the current image at the corresponding time of the conference video;
generating an empty matrix with 0 gray value, whose resolution is equal to that of the current image at the corresponding time of the conference video;
assigning the empty matrix with gray value information corresponding to the text information pixel by pixel, so as to obtain a matrix image corresponding to the text information;
wherein a resolution of the matrix image is equal to that of the current image at the corresponding time of the conference video; and
summing the matrix image and the current video image of the conference video to generate a conference video with subtitle information.

14. The projection-type video conference system according to claim 8, wherein the localization and noise reduction module is configured concretely to:
convert the voice signals into a 16-bit Pulse Code Modulated (PCM) data stream;
perform echo cancellation processing on the PCM data stream, to generate a first signal;
filter the first signal to generate a first filtered signal;
detect, based on the first signal and the first filtered signal, a direction of a voice source and form a pickup beam area, to generate a detected signal;
perform noise suppression processing on the detected signal, to generate a second signal; and
perform reverberation elimination processing on the second signal, to generate a third signal.

15. The projection-type video conference system according to claim 6, wherein the information fusion processor is configured concretely to:
obtain display resolution of the current image at the corresponding time of the conference video;
generate an empty matrix with 0 gray value;
assign the empty matrix with gray value information corresponding to the text information pixel by pixel, so as to obtain a matrix image corresponding to the text information; wherein a resolution of the matrix image is equal to that of the current image at the corresponding time of the conference video; and
sum the matrix image and the current video image of the conference video to generate the conference video with subtitle information.

16. The video projecting method according to claim 10, wherein before the copying the voice information to generate a copied voice information, the video projecting method further comprises:
converting the voice signals into a 16-bit Pulse Code Modulated (PCM) data stream;
performing echo cancellation processing on the PCM data stream, to generate a first signal;
filtering the first signal to generate a first filtered signal;
detecting, based on the first signal and the first filtered signal, a direction of a voice source and forming a pickup beam area, to generate a detected signal;
performing noise suppression processing on the detected signal, to generate a second signal; and
performing reverberation elimination processing on the second signal, to generate a third signal.
